(19) United States
(12) Patent Application Publication
(10) Pub. No.: US 2006/0146523 A1
(43) Pub. Date: Jul. 6, 2006

(54) Fluorescent flood light

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/026,266

(22) Filed: Dec. 30, 2004

(51) Int. Cl. F21V 23/02

(52) U.S. Cl. 362/183; 362/260

(57) ABSTRACT

This present invention is relates to a fluorescent flood light and more particularly, to a fluorescent flood light with a handle and two supporting legs. Said two supporting legs may move relatively and interactively between position one and position two. If both said supporting legs are adjusted to an angle over 90°, user may place said light on shoulder to provide long distance lighting. Said supporting legs can also provide an adjustable mean with a tight or loose positions so as to controlling such supporting legs in a locked position or in a rotating position to reach said best lighting range and lighting angles through said attached hinge to any position within 270 degrees circular ark. Said present invention is an important source of light used in marine, army, public security, firefighting, emergency treatment, disciplined troop, architecture and civil vessels, as well as emergency treatment in daily life.

### BACKGROUND OF SAID PRESENT INVENTION

1. Field of Invention

Said present invention is relates to a fluorescent flood light and more particularly, to a fluorescent flood light with a handle and two supporting legs. Said two supporting legs may move relatively and interactively between position one and position two. If both said supporting legs are adjusted to an angle over 90°, user may place said light on shoulder to provide long distance lighting.

2. Description of Related Arts

Currently, most of said lighting equipment used at home or other places, which may be directly plugged to said external power source, allow said user to hold them by hand, or they may be affixed to said wall and ceiling.

Fluorescent flood light with focused beams, spotlights or searchlights, whether battery-powered or line-powered, are commonly used by military, law enforcement, fire and rescue personnel, security personnel, hunters and recreational boaters among others for nighttime surveillance in any application where a high intensity spotlight is required. Said conditions of use are highly varied, but generally require said light to deliver a desired field of view at long distances, be reliable, durable and field maintainable in order for it to be practically used in said designed applications. Typically said light is hand carried and must be completely operable using simple and easily access manual controls, which do not require said use of two hands. In prior art xenon short-arc searchlights or illumination systems, whether handheld, portable or fixed mounted, said luminance distribution of said arc has been positioned facing in said direction of said beam (cathode to said rear), to provide a uniform beam pattern when said arc is at said focal point of said parabolic reflector. When said arc is moved slightly beyond (or slightly rearward of) said reflector's focal point, said combination of a placing all available light in said high magnification section of said reflector and collecting it in a slightly convergent manner produces roughly twice said operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

U.S. Pat. No. 6,685,337 provides a lanterns which combine both a flashlight with a candle together to ensure said lantern can still light up when power source is done or batteries are all used up. However, said lighting range, lighting angles and said lighting power of a candle are minimal. Such lantern light up by a candle will not be said most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting legs. Said mounting is a tripod mount so that said portable searchlight may be fixed in said field to a tripod with said second device. Said mounting on said handle is a thumbscrew mount to permit mounting of an optical detection device onto said searchlight and rigidly fixed to said housing. However, this lantern provide without no ability to move any angle to obtain a better light range.

### SUMMARY OF SAID PRESENT INVENTION

Said main object of said present invention is to provide a fluorescent flood light having a supporting means and such supporting means can provide an ability to rotate an angle more than 90 degree so as to provide a platform for user to place said fluorescent flood light on shoulder.

Another object of said present invention is to provide a fluorescent flood light having a supporting means and such supporting mean can provide an ability to rotate and/or to move any angles within 270 degree circular arc.

Another object of said present invention is to provide a fluorescent flood light having an ability to adopt difference power source supplies.

Another object of said present invention is to provide a fluorescent flood light having a supporting means and such supporting mean can provide an adjustable mean with a tight or loose positions so as to controlling such supporting legs in a locked position or in a rotating position to reach said best lighting range and lighting angles.

Accordingly, to achieve said above objects, a fluorescent flood light comprises:

a three dimensional cylinder housing, inside of it contains a mean of lighting source;

a plurality of reflector is fixed around said mean of light source; and

a transparent front flat board;

a sealed packing collar is connecting a inner portion of said transparent front flat board and said reflector which resides inside of an annular nut. Said annular nut providing a fixed position and a disassembled position on front portion of said housing. Surface of said annular nut, which is located in front of said housing, set an annular shockproof nut. It is made of rubber or other soft material to prevent said fluorescent flood light flood light from shocks or quakes when excessive external force applied to it.

### BRIEF DESCRIPTION OF SAID DRAWINGS

FIG. 1 is a side view of said present invention.

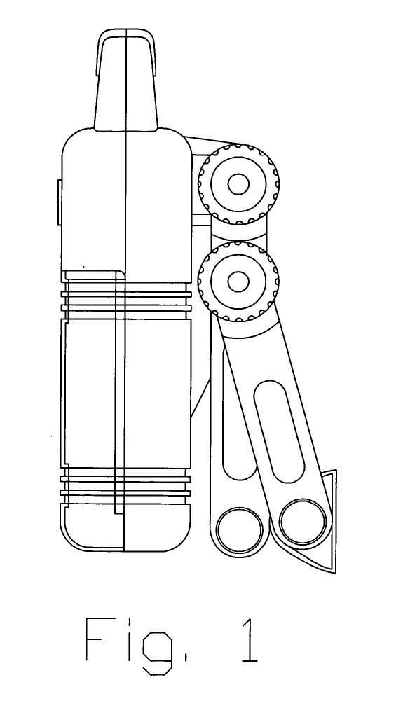

FIG. 2 is a side sectional view thereof;

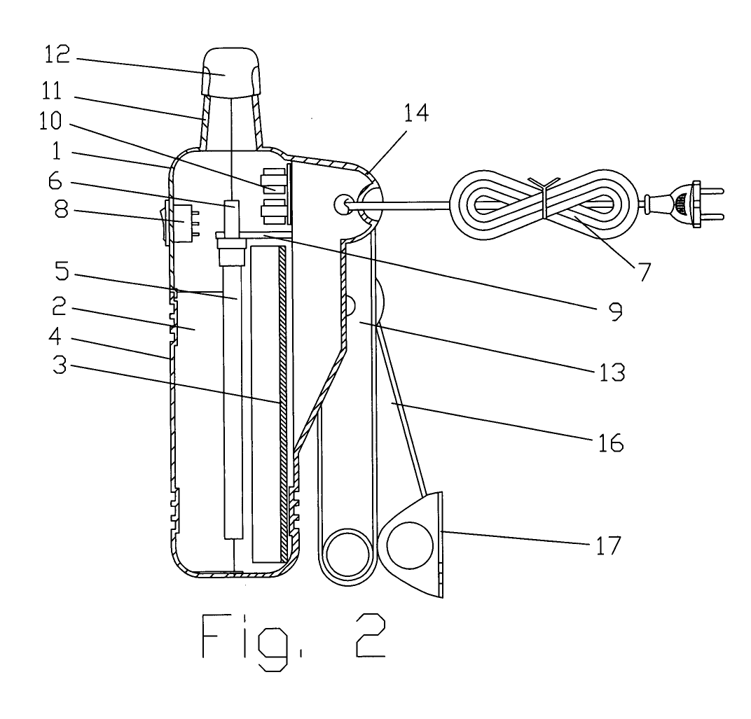

FIG. 3 is a top view thereof;

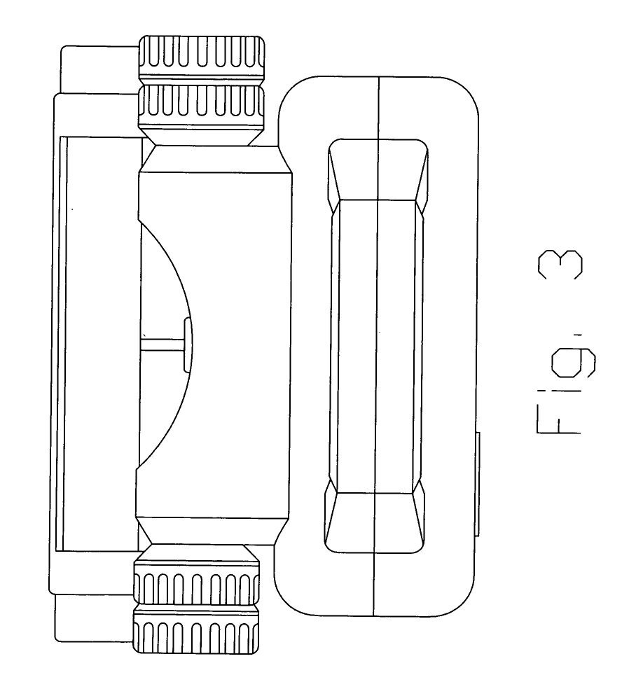

FIG. 4 is an underneath view thereof;

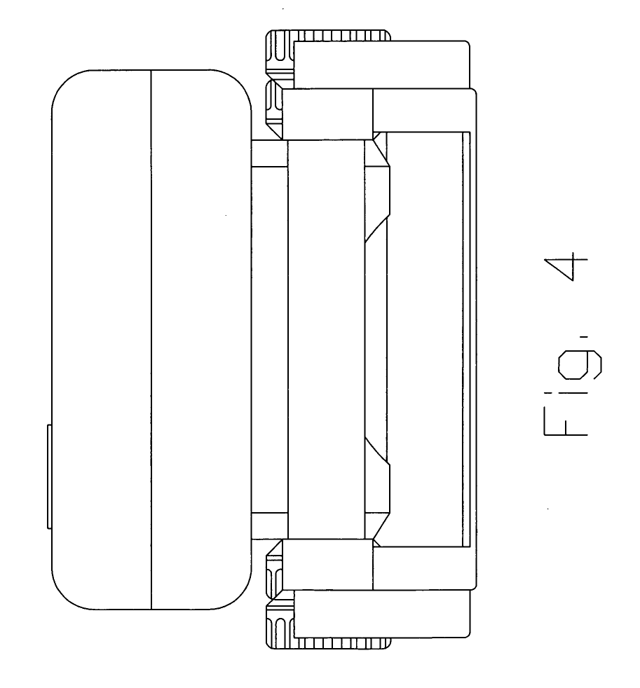

FIG. 5 is a front view thereof;

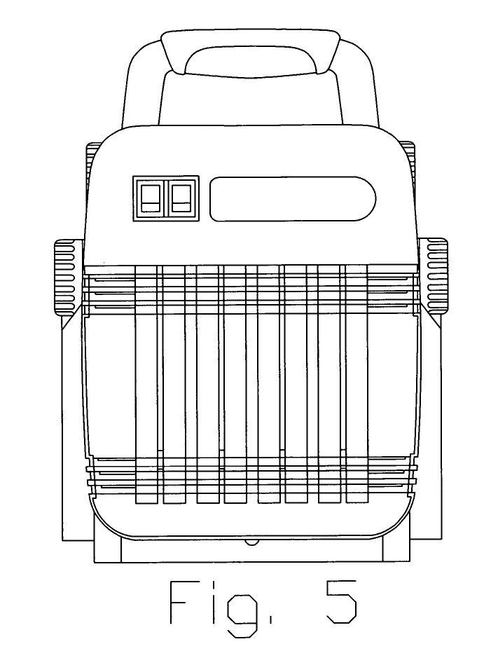

FIG. 6 is a rear view thereof;

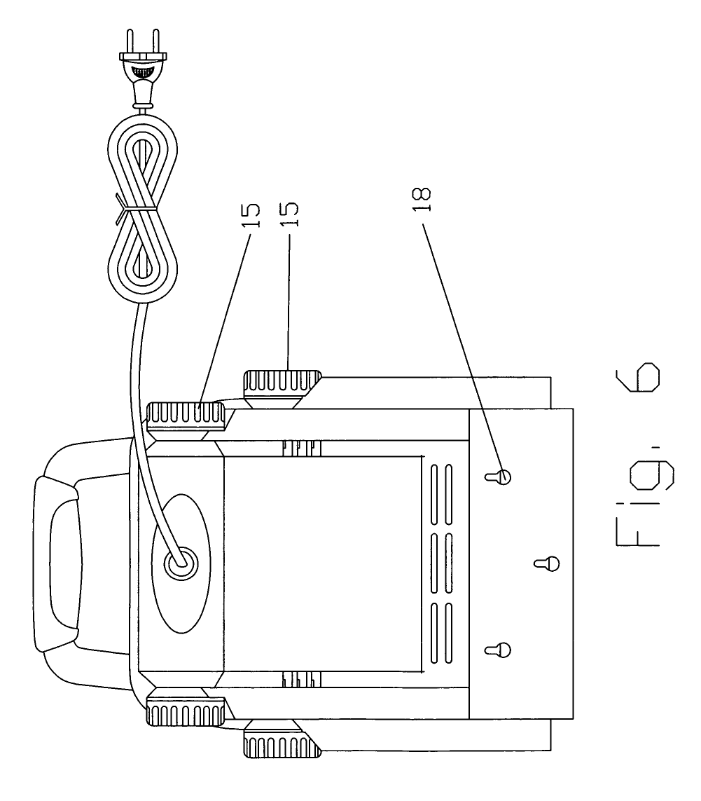

FIG. 7 is another side view thereof;

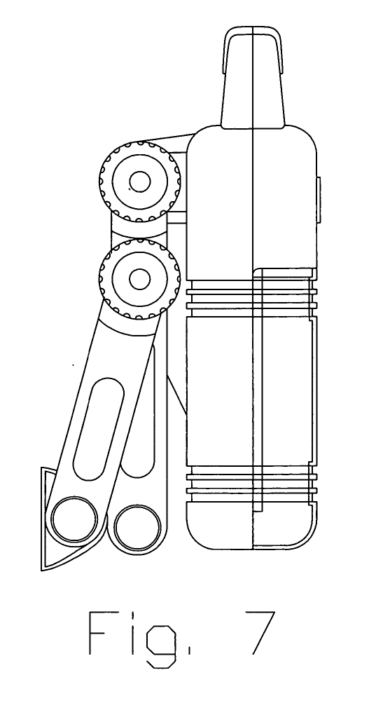

FIG. 8 is a side view with support activated thereof;

FIG. 9 is a side view with support activated in 2 other angles thereof.

### DETAILED DESCRIPTION OF SAID PREFERRED EMBODIMENT

This present invention comprises of a three dimensional cylinder illuminant (1). Inside said illuminant (1), there is a light source (2), a reflector (3) generally in a shape of a parabola, and a transparent front light shade (4). Said light shade (4) provides a removed and affixed means to a front portion of said illuminant (1) to allow user to replace or clean an energy-saving fluorescent flood light bulb (5).

As illustrated in all figures, said light source (2) consists of four energy-saving light bulbs (5). Said energy-saving light bulbs are affixed to a base (6) and this light is powered through a power cord (7) inside said illuminant (1). Power passes through said power cord (7), which is connected to said switch (8) located at said front portion of said illuminant (1) and then to said base (6) of said illuminant (1), which is connected to said energy-saving fluorescent flood light bulbs (7). Obviously, said power is directly supplied by said civil power source.

Said light base (6) is affixed on said flexible light frame (9) located on said top of said illuminant (1). On top of said light frame (9), there is an electric circuit driver (10) that may activate said energy-savings fluorescent flood light bulb (7) to illuminate.

Said illuminant (1) has a hand grip (11) on top. Said hand grip (11) is a rectangular cylinder structure. On said hand grip (11), there is a hand grip piece (12) which is made of soft material to provide said user a sense of comfort when holding it.

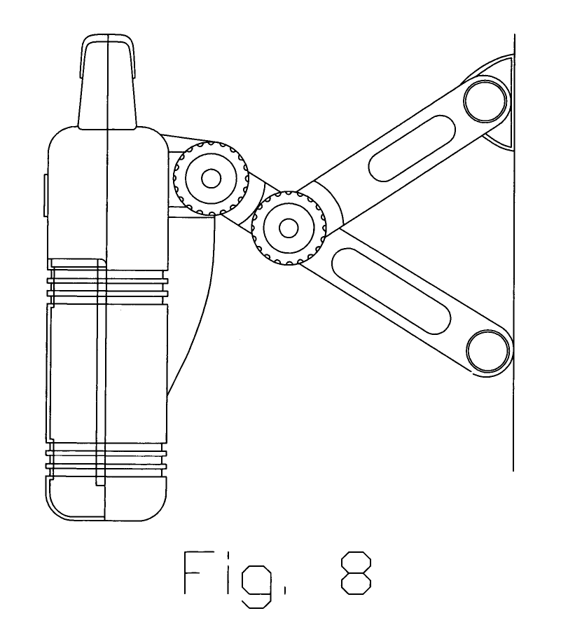

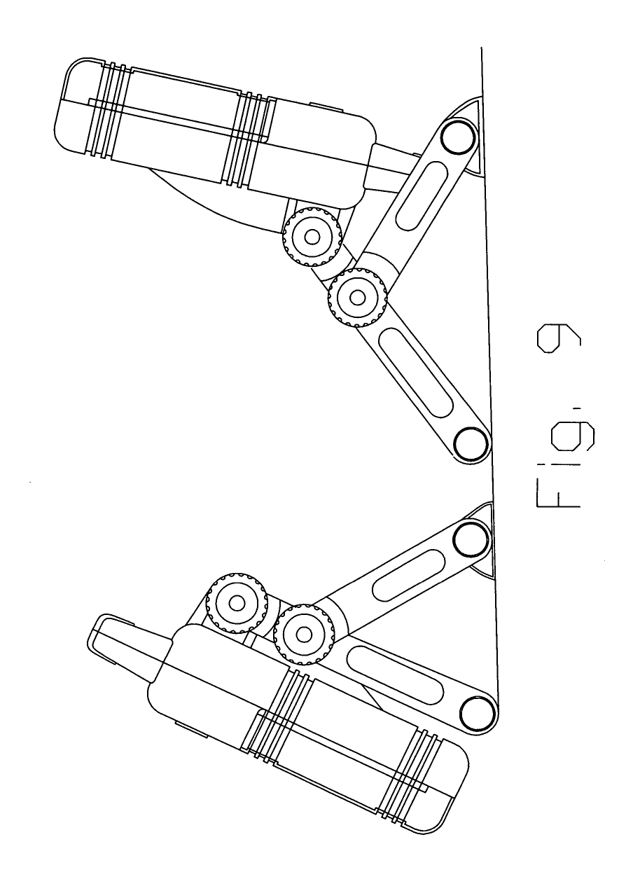

Said long stand (13) is flexibly attached to said flange (14) located at said rear of said illuminant (1), and may be tightened up with an adjustable latch (15) to fasten said long stand (13). Said long stand (13) may pivot around said hinge and remain at any position within said 190° arc. In said center of said long stand (13) is another short stand (16). Said short stand (16) may flexibly connect to said center of said long stand (13) and may be fastened to said adjustable latch (15) to affix said short stand (16) in place. Said short stand (16) may pivot around said hinge and remain at any position within said 270° arc, so as to provide a support for said illuminant (1) on a plant surface to achieve said optimal lighting angle, as indicated in FIG. 9. On said bottom of said short stand (16) there is a flexible plate (17). On said flexible plate (17), there are three screw holes (18) for hanging. This flexible plate (17) may be flexibly moved to connect to said bottom of said short stand (16). Said flexible plate (17) may pivot around said hinge and remain at any position within said 360° arc. This way, said stands will provide a support for said illuminant (1) on said plane surface and allow optimal lighting angle, as indicated in FIG. 8.

In another word, this fluorescent flood light is used as a flashlight, and is also very easy to carry by hand. It is very easy to use when searching targets or when multiple lighting angles are required.

On said bottom of this fluorescent flood light, there are adjustable long stand (13) and short stand (16). Obviously, it allows users, who are using their hands to work and may not hold said light by hand and yet require sufficient light, to affix said light on a supporting surface such as said desk or ground, and it may be adjusted to achieve said optimal lighting angle. When using this light at home, at work or in said garage, it may be affixed to said ground or on said wall, and adjusted to an optimal lighting angle.

The present invention is an important source of light used in marine, army, military, public security, firefighting, emergency treatment, disciplined troop, architecture and civil vessels, as well as for emergency treatment in daily life.

What is claimed is:

1. A fluorescent flood light comprises:
a three dimensional cylinder housing, inside of it contains a mean of lighting source;
a plurality of reflector is fixed around said mean of light source; and
a plurality of power cord, and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
having a supporting means and such supporting mean can provide an adjustable mean with a tight or loose positions so as to controlling such supporting legs in a locked position or in a rotating position to reach said best lighting range and lighting angles; and
having two supporting legs can move relatively and interactively between position one and position two allowing tightly affixed at any position to provide an adjustable lighting angle, said supporting legs provide a support on plane surface for to provide a distance lighting mean with any angle over 90°, and
said supporting legs can also provide rotating positions through said adjustable hinge to any position within 270 degrees circular arc. Said provide support for said housing in a horizontal position to get said best lighting angle, and having a handle attached to said housing providing mean of carrying.

2. A fluorescent flood light as recited in claim 1, wherein, said fluorescent flood light is further comprises:
at least one light bulb,
at least one arc shaped reflector,
at least one set of main switch,
at least one power receptacle for external electricity,
at least one transformer, and
at least one set of circuitry and power supply.

3. A fluorescent flood light as recited in claim 1, wherein supporting legs can provide an adjustable mean with a tight or loose positions so as to controlling such supporting legs in a locked position or in a rotating position to reach said best lighting range and lighting angles through said attached hinge to any position within 270 degrees circular ark. Said supporting legs can move relatively and interactively between position one and position two allowing tightly affixed at any position to provide an adjustable lighting angle, said supporting legs provide a support on plane surface for to provide a distance lighting mean with any angle over 90°, Said legs provide supports for said housing.

4. A fluorescent flood light as recited in claim 1, wherein said fluorescent flood light is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

5. A fluorescent flood light as recited in claim 1, wherein said fluorescent flood light comprises a lighting source, has an energy saving florescent light bulb, which is located on a light base. Electricity is provided by a power source within said housing. Electricity current goes through power cord to said insides of electrical circuitry of said housing and transformer, while connects power receptacle, on/off switch, and links up with energy saving florescent bulb.

6. A fluorescent flood light as recited in claim 1, wherein said fluorescent flood light can draw electricity either from AC power outlet provided from public utility or from said chargeable battery directly.

7. A fluorescent flood light as recited in claim 1, wherein said fluorescent flood light further comprises:
a handle in a rectangular shape is longitudinally attached to said housing. A front and rear of said handle are equipped with stripes so as to provide a mean of carrying.

8. A fluorescent flood light as recited in claim 1, wherein said fluorescent flood light further comprises:
a battery cover is located at rear portion of said housing. Metal screws tightly locked a battery cover to said rear bump of said housing. A seal packing collar fastens said light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal said entrance of said external receptacle, thus prevent water and is more durable.

9. A fluorescent flood light as recited in claim 2, wherein supporting legs can provide an adjustable mean with a tight or loose positions so as to controlling such supporting legs in a locked position or in a rotating position to reach said best lighting range and lighting angles through said attached hinge to any position within 270 degrees circular ark. Said supporting legs can move relatively and interactively between position one and position two allowing tightly affixed at any position to provide an adjustable lighting angle, said supporting legs provide a support on plane surface for to provide a distance lighting mean with any angle over 90°, Said legs provide supports for said housing.

10. A fluorescent flood light as recited in claim 2, wherein said fluorescent flood light is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

11. A fluorescent flood light as recited in claim 2, wherein said fluorescent flood light comprises a lighting source, has an energy saving florescent light bulb, which is located on a light base. Electricity is provided by a power source within said housing. Electricity current goes through power cord to said insides of electrical circuitry of said housing and transformer, while connects power receptacle, on/off switch, and links up with energy saving florescent bulb.

12. A fluorescent flood light as recited in claim 2, wherein said fluorescent flood light can draw electricity either from AC power outlet provided from public utility or from said chargeable battery directly.

13. A fluorescent flood light, as recited in claim 1, wherein said fluorescent flood light further comprises:
a handle in a rectangular shape is longitudinally attached to said housing. A front and rear of said handle are equipped with stripes so as to provide a mean of carrying.

14. A fluorescent flood light as recited in claim 1, wherein said fluorescent flood light further comprises:
one screw hole for hanging. This flexible plate may be flexibly connected to the bottom of the short stand and the flexible plate may pivot around the hinge, and move to any desired position within a 360° arc.
A seal-packing collar fastens said light fixture's rear inside with a front end of said battery cover. Said battery cover provides disassembling position or a fixed position at rear portion of said housing.
